(19) United States
(12) Patent Application Publication
(10) Pub. No.: US 2016/0012640 A1
(43) Pub. Date: Jan. 14, 2016

(54) USER-GENERATED DYNAMIC VIRTUAL WORLDS

(71) Applicant: Microsoft Corporation, Redmond, WA (US)

(72) Inventor: Robin Abraham, Redmond, WA (US)

(21) Appl. No.: 14/330,136

(22) Filed: Jul. 14, 2014

(51) Int. Cl. G06T 19/00; G06F 3/01; G06T 19/20; G06T 1/00; G06T 15/04; G06T 17/20; H04N 5/225; G06F 3/16

(52) U.S. Cl. CPC G06T 19/006; H04N 5/225; G06F 3/011; G06F 3/017; G06F 3/167; G06T 1/0007; G06T 15/04; G06T 17/20; G06T 19/20; G06T 2219/012; G06T 2219/024; G06T 2219/2021; G06T 2219/2024

(57) ABSTRACT

A cloud-based virtual world generation platform enables users to create content that can be incorporated into games as dynamic virtual worlds. The user-created content employs three-dimensional (3D) models of the user's environment using data that is captured by a camera system having depth sensing capabilities. A composition service exposed by the platform uses the captured data to generate a wireframe model that can be manipulated by the user with tools for applying surface textures (i.e., “skins”) and lighting, and for controlling other attributes and characteristics of the modeled environment. Other tools enable the user to select a particular physics engine that can control how the modeled user environment behaves during gameplay. The platform also exposes a rendering service with which a game can interact to access the user-generated content so that a modeled user environment can be utilized and incorporated into the game as a dynamic virtual world.

### BACKGROUND

User involvement is vital for the success of video game titles. To draw in and engage end users, many of the currently available games support various features that are not necessarily a key part of the basic gameplay. These features are incorporated to support social interaction within games and to promote discussions about games in order to enhance user engagement. For example, some games allow users to invite or challenge friends and family to join them so they can all play online together. Other games provide for users to send gifts or bonus items to people within their social circles. Games also frequently support textual and/or voice chat so that users can communicate with one another while playing a game.

Many games have associated online communities hosted as user forums. For successful game franchises, these communities are often very active and there can be a lot of discussion and interaction among the gamers. Some currently available games also have map builder plug-ins and other features that enable users to create new maps that can be incorporated as part of the gameplay. Other games allow users to create or modify virtual environments. However, those approaches tend to be limited, restrictive, and tedious to update. Moreover, they lack richness and detail and the novelty wears off rather quickly since the content can be pretty bland and lacks any active participation or contributions from users.

This Background is provided to introduce a brief context for the Summary and Detailed Description that follow. This Background is not intended to be an aid in determining the scope of the claimed subject matter nor be viewed as limiting the claimed subject matter to implementations that solve any or all of the disadvantages or problems presented above.

### SUMMARY

A cloud-based virtual world generation platform enables users to create content that can be incorporated into games running on a multimedia console as dynamic virtual worlds. The user-created content employs three-dimensional (3D) models of the user's environment, such as a room and the objects in it, using data that is captured by a camera system having depth sensing capabilities. A composition service exposed by the platform uses the captured data to generate a wireframe model that can be manipulated by the user with tools for applying surface textures (i.e., “skins”) and lighting, and for controlling other attributes and characteristics of the modeled environment, in order to achieve a desired look and feel for the user-generated content. Other tools enable the user to select a particular physics engine that can control how the modeled user environment behaves during gameplay. The platform also exposes a rendering service with which a game can interact to access the user-generated content so that a modeled user environment can be utilized and incorporated into the game as a dynamic virtual world.

Advantageously, the virtual world generation platform enables users to extend and enhance the experience of playing their favorite games. User-generated content can be shared with other users to greatly expand the scope of games and create a large number of new dynamic virtual worlds that can be experienced and explored. Sharing user-generated content can also be expected to be a popular way for users to socially interact as part of an overall gaming experience.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure.

### DESCRIPTION OF THE DRAWINGS

FIG. 1 shows an illustrative computing environment in which the present user-generated dynamic virtual worlds may be implemented;

FIGS. 2-4 show pictorial views of a user interacting with a multimedia console in a typical home environment;

FIG. 5 shows an illustrative wireframe model used in a typical gaming scenario;

FIG. 6 shows a screen capture of a rendered scene in a typical gaming scenario in which skins are applied to produce a particular look and feel in the game;

FIG. 7 shows an illustrative virtual world generation platform that interacts with a user-generated content application and game that are supported by a multimedia console;

FIG. 8 shows an illustrative taxonomy of tools that may be exposed by the user-generated content application;

FIG. 9 shows an illustrative environment that may be captured by an environment modeling tool;

FIG. 10 shows an illustrative taxonomy of functionalities that may be exposed by a skinning tool;

FIG. 11 shows an illustrative taxonomy of physic models that may be exposed by a physics engine tool;

FIG. 12 shows illustrative interactions between the tools exposed by the user-generated content application and the composition and rendering services;

FIG. 13 is a flowchart of an illustrative method for generating a virtual model of a user environment;

FIG. 14 shows illustrative interactions between a game and the rendering service;

FIG. 15 illustratively shows how a rendering service can operate synchronously and/or asynchronously;

FIG. 16 is a flowchart of an illustrative method for providing user-generated content to the game;

FIG. 17 shows various alternative technologies that may be incorporated into a mobile device to capture user environments;

FIG. 18 shows block diagrams of an illustrative camera system and multimedia console that may be used in part to implement the present user-generated dynamic virtual worlds;

FIG. 19 shows a functional block diagram of an illustrative multimedia console that may be used in part to implement the present user-generated dynamic virtual worlds;

FIG. 20 is a block diagram of an illustrative computer system such as a personal computer (PC) or server that may be used in part to implement the present user-generated dynamic virtual worlds; and

FIG. 21 shows a block diagram of an illustrative computing platform that may be used in part to implement the present user-generated dynamic virtual worlds.

Like reference numerals indicate like elements in the drawings. Elements are not drawn to scale unless otherwise indicated.

### DETAILED DESCRIPTION

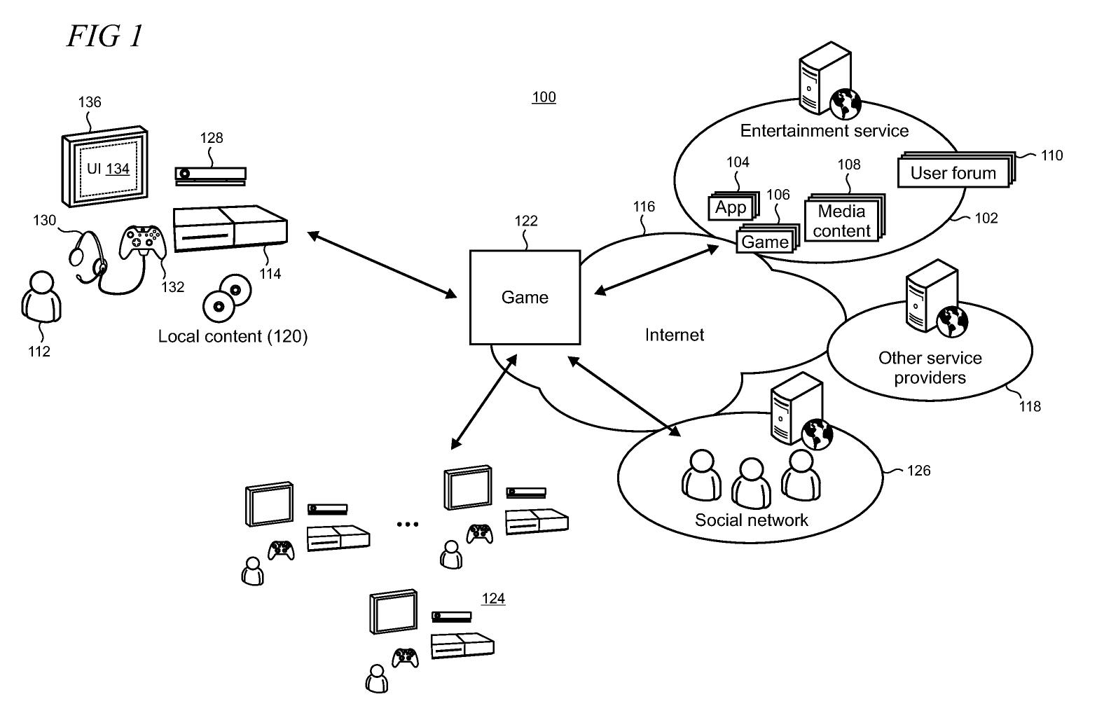

FIG. 1 shows an illustrative computing environment 100 in which the present user-generated dynamic virtual worlds may be implemented. An entertainment service 102 typically can expose applications (apps) 104, games 106, and media content 108 such as television shows and movies, and user forums 110 to a user 112 of a multimedia console 114 over a network such as the Internet 116. Other service providers 118 that can provide various other services such as communication services, financial services, travel services, news and information services, etc. may also be in the environment 100.

Local content 120, including apps, games, and/or media content may also be utilized and/or consumed in order to provide a particular user experience such as a game 122 in the environment 100. In some cases the local content 120 is obtained from removable sources such as optical discs including DVDs (Digital Versatile Discs) and CDs (Compact Discs), while in others, the local content is downloaded from a remote source and saved locally. The game 122 may execute locally on the multimedia console 114, be hosted remotely by the entertainment service 102, or use a combination of local and remote execution in some cases using local or networked content/apps/games as appropriate. The game 122 may also be one in which multiple other players 124 with other computing devices can participate. In some implementations, user experiences associated with the game 122 can also be shared on a social network 126 or through the user forums 110.

The user 112 can typically interact with the multimedia console 114 using a variety of different interface devices including a camera system 128 that can be used to sense visual commands, motions, and gestures, and a headset 130 or other type of microphone or audio capture device/system. In some cases a microphone and camera can be combined into a single device. The user 112 may also utilize a controller 132 to interact with the multimedia console 114. The controller 132 may include a variety of physical controls including joysticks, a directional pad (“D-pad”), and buttons. One or more triggers and/or bumpers (not shown) may also be incorporated into the controller 132. The user 112 will typically interact with a user interface 134 that is shown on a display device 136 such as a television or monitor.

It is emphasized that the number of controls utilized and the features and functionalities supported by the user controls implemented in the camera system 128, audio capture system, and controller 132 can vary from what is shown in FIG. 1 according to the needs of a particular implementation. In addition, in the description that follows, various gestures, button presses, and control manipulations are described. It is noted that those actions are intended to be illustrative. For example, the user may actuate a particular button or control, or perform a particular gesture in order to prompt a system operating on the multimedia console 114 to perform a particular function or task. It will be appreciated that the particular mapping of controls to functions can vary from that described below according to the needs of a particular implementation. As used here, the term “system” encompasses the various software (including the software operating system (OS)), hardware, and firmware components that are instantiated on the multimedia console and its peripheral devices in support of various user experiences that are provided by the console.

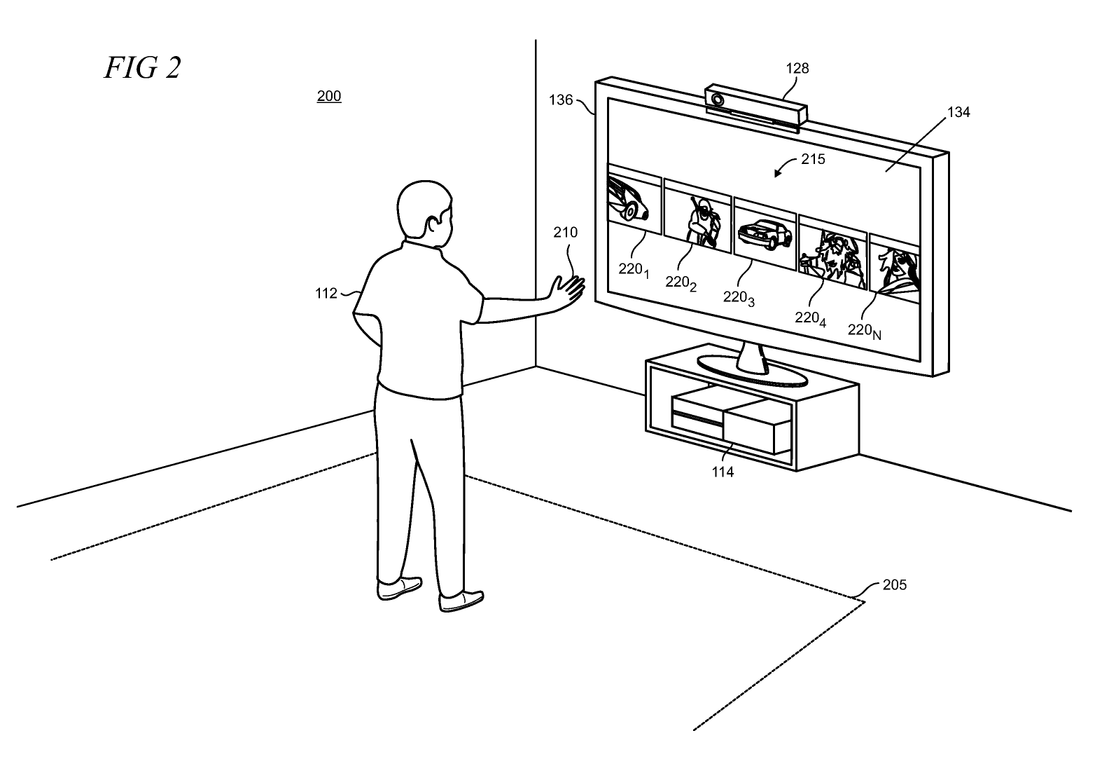

FIGS. 2-4 show pictorial views of an illustrative example of the present user-generated dynamic virtual worlds in which the user 112 interacts with the multimedia console 114 in a typical home environment 200. The multimedia console 114 is typically configured for running gaming and non-gaming applications using local and/or networked programming and content, playing pre-recorded multimedia such as optical discs including DVDs (Digital Versatile Discs) and CDs (Compact Discs), streaming multimedia (e.g., music and video) from a network, participating in social media, browsing the Internet and other networked media and content, or the like using a coupled audio/visual display such as the television 136. In some implementations, the multimedia console 114 may be configured to support conventional cable television (CATV) sources using, for example, an HDMI (High Definition Multimedia Interface) connection.

The multimedia console 114 is operatively coupled to the camera system 128 which may be implemented using one or more video cameras that are configured to visually monitor a physical space 205 which is indicated generally by the dashed line in FIG. 2 that is occupied by the user 112. As described below in more detail, camera system 128 is configured to capture, track, and analyze the movements and/or gestures of the user 112 so that they can be used as controls that may be employed to affect, for example, an app or an operating system running on the multimedia console 114. Various motions of the hands 210 or other body parts of the user 112 may correspond to common system-wide tasks such as selecting a game or other application from a main user interface.

For example, the user 112 can navigate among selectable objects 215 that include various icons 220_{1-N} that are shown on the UI 134 on the television 136, browse through items in a hierarchical menu, open a file, close a file, save a file, or the like. In addition, the user 112 may use movements and/or gestures to end, pause, or save a game, select a level, view high scores, communicate with a friend, etc. Virtually any controllable aspect of an operating system and/or application may be controlled by movements of the user 112. A full range of motion of the user 112 may be available, used, and analyzed in any suitable manner to interact with an application or operating system that executes on the multimedia console 114. While the user 112 is shown standing in FIG. 2, the camera system 128 can also recognize gestures that are performed while the user is seated.

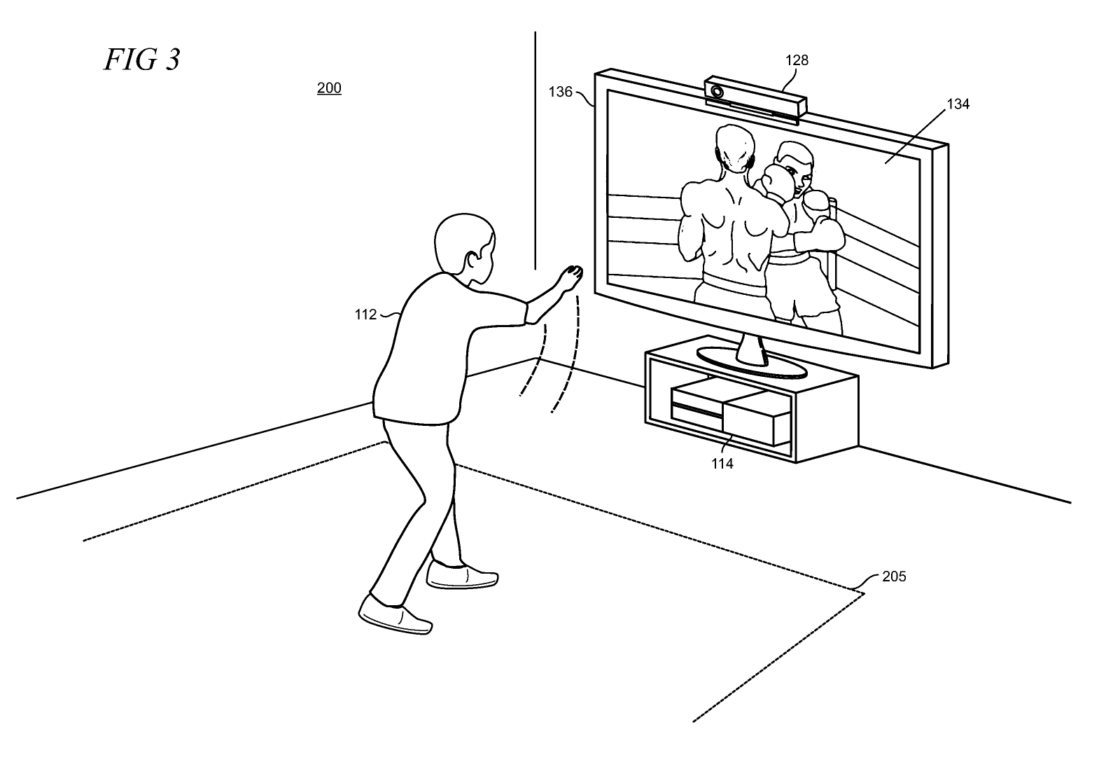

The camera system 128 can also be utilized to capture, track, and analyze movements by the user 112 to control gameplay as a gaming application executes on the multimedia console 114. For example, as shown in FIG. 3, a gaming application such as a boxing game employs the UI 134 to provide a visual representation of a boxing opponent to the user 112 as well as a visual representation of a player avatar that the user 112 may control with his or her movements. The user 112 may make movements (e.g., throwing a punch) in the physical space 205 to cause the player avatar to make a corresponding movement in the game space. Movements of the user 112 may be recognized and analyzed in the physical space 205 such that corresponding movements for game control of the player avatar in the game space are performed.

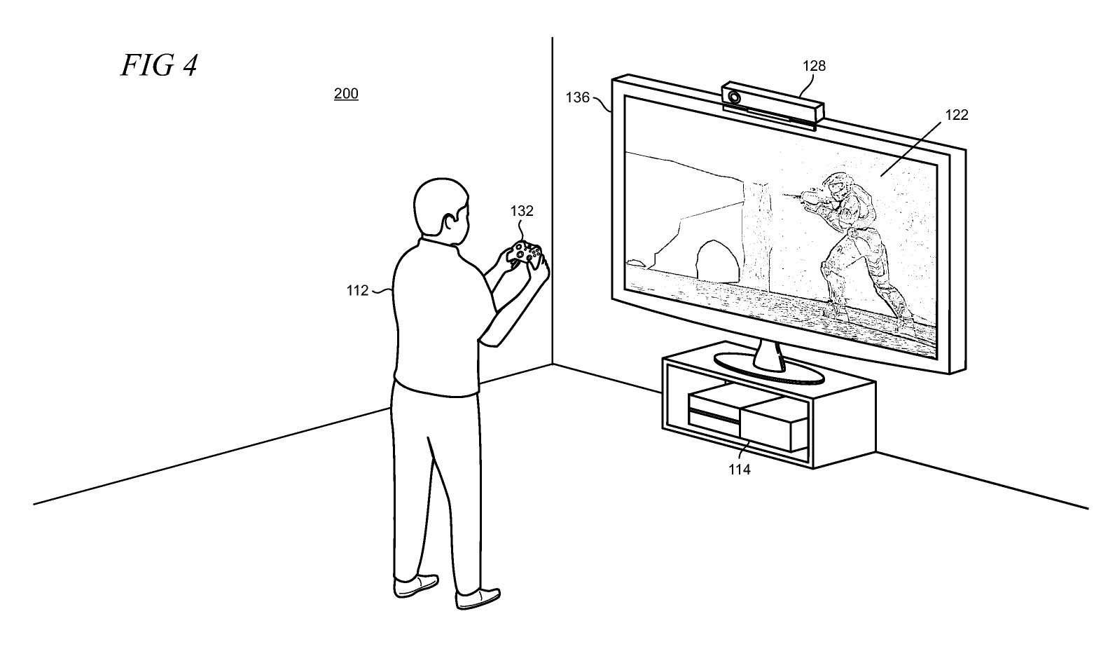

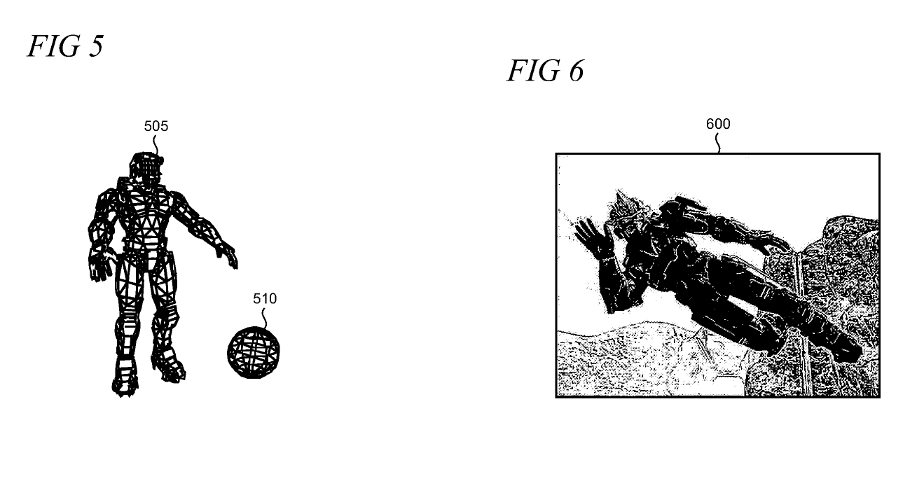

FIG. 4 shows the user 112 using the controller 132 to interact with the game 122 that is being played on the multimedia console 114 and shown on the display device 136. As shown in FIG. 5, the game 122 typically utilizes wireframe models to represent the various objects, as indicated by reference numerals 505 and 510, which are utilized in the virtual world supported by the game. The wireframe models are covered with a texture known as a “skin” that provides a particular look and feel, as selected by the game developers, to the game as shown in the gameplay screen shot 600 in FIG. 6. The game 122 then animates the skinned wireframe models as appropriate to the progression of gameplay.

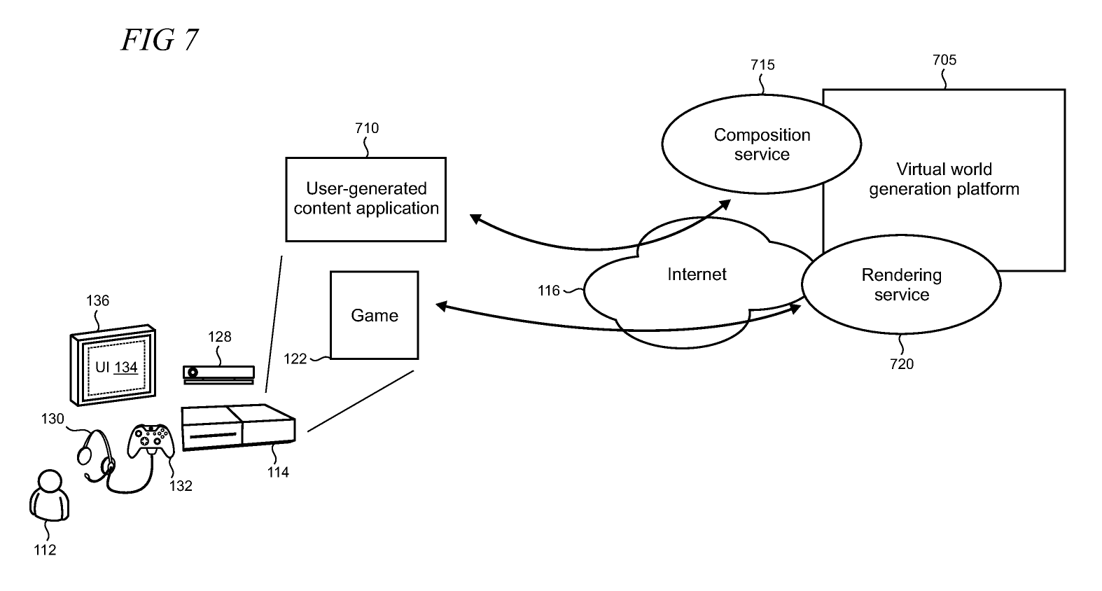

FIG. 7 shows an illustrative virtual world generation platform 705 that interacts with a user-generated content application 710 and the game 122 that are supported by a multimedia console 114. The virtual world generation platform 705 may typically be implemented as a cloud-based service that is accessible over an Internet connection, as shown, and exposes a composition service 715 and a rendering service 720. The user-generated content application 710 is typically implemented using locally executing code. However in some cases, the application 710 may rely on services and/or remote code execution provided by remote servers or other computing platforms such as those supported by external service providers, the virtual world generation platform 705, or other cloud-based resources.

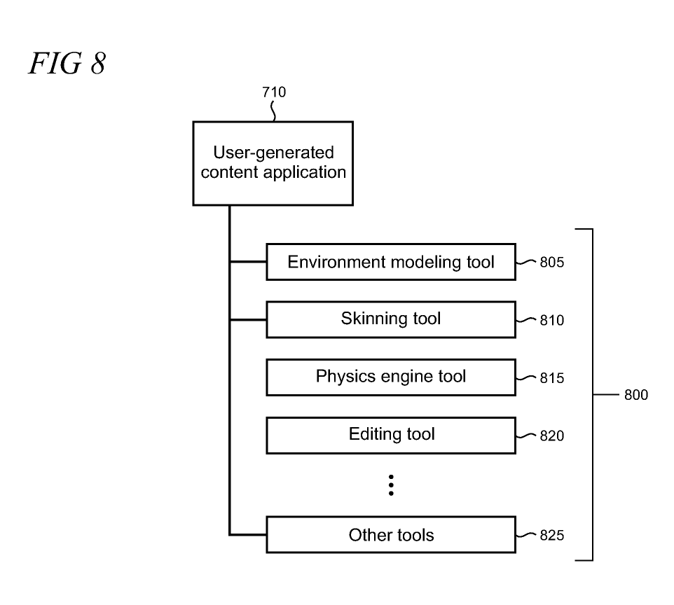

The user-generated content application 710 exposes a variety of tools to the user 112. As shown in FIG. 8, these tools 800 illustratively include an environment modeling tool 805, a skinning tool 810, a physics engine tool 815, and an editing tool 820. Other tools 825 can also be provided as may be needed in other implementations.

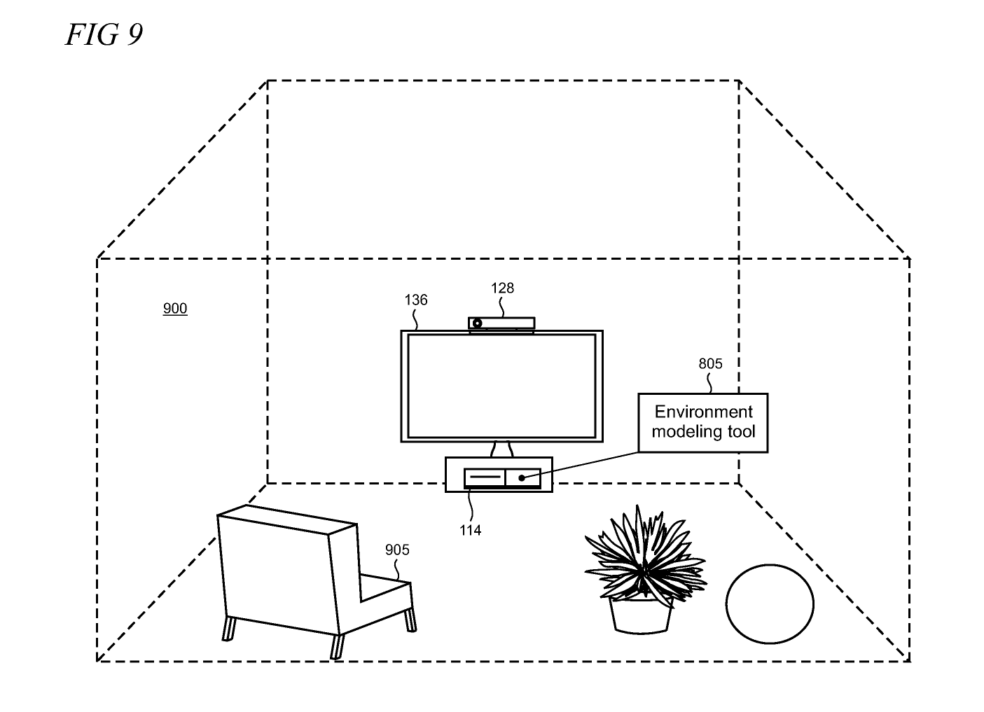

The environment modeling tool 805 may be configured to capture data that is descriptive of an environment that the user wishes to employ as part of user-generated content. For example, as shown in FIG. 9, the environment modeling tool runs as part of the user-generated content application on the multimedia console 114. The camera system 128 that is operatively coupled to the multimedia console 114 may capture data that is descriptive of the particular room in which the console is located and its contents. The room and its contents are collectively referred to here as the user's environment and indicated in FIG. 9 by reference numeral 900. The contents can include furnishing and objects, etc. (as representatively indicated by reference numeral 905). As the camera system 128 includes depth sensing capabilities, it may generate data that describes the user's environment 900 in three dimensions.

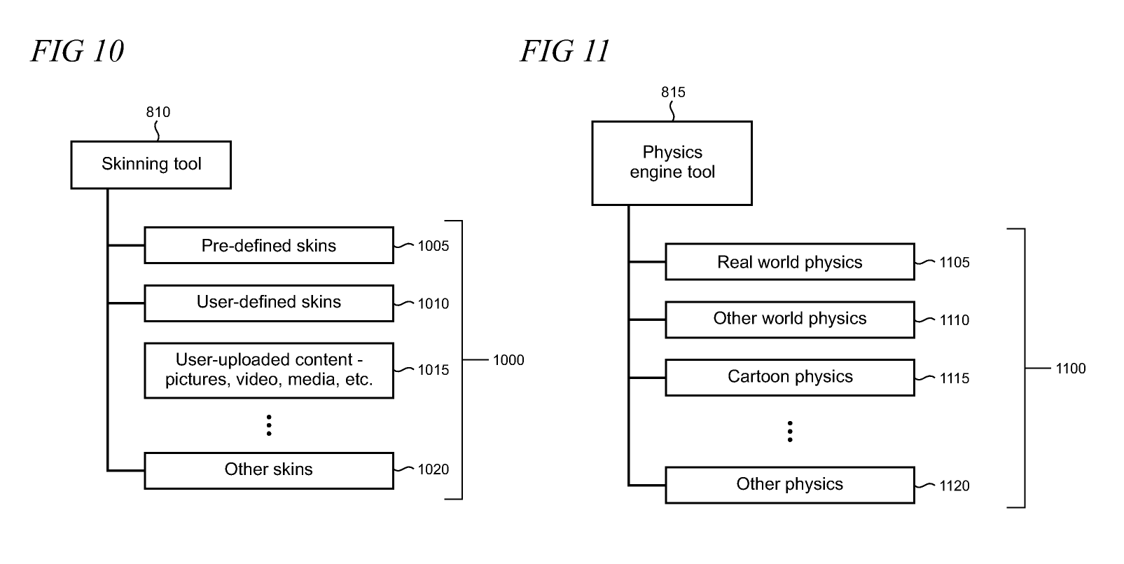

As shown in the taxonomy 1000 of skinning options in FIG. 10, the skinning tool 810 may be configured to enable the user to employ pre-defined skins 1005, user-defined skins 1010, content 1015 that is uploaded to the virtual world generation platform 705 by the user such as pictures, video, media, and the like, and other skins 1020 as may be appropriate for a given implementation.

As shown in the taxonomy 1100 of physics engines in FIG. 11, the physics engine tool 815 may be configured to enable the user to apply various physics engines to user-generated content including real world physics 1105, other world physics 1110 (such as physics that may be applicable to other real places in the universe such as the Moon, outer space, under water, etc.), cartoon physics 1115 (where the imaginary laws of physics are utilized), and other physics 1120 as may be appropriate for a given implementation.

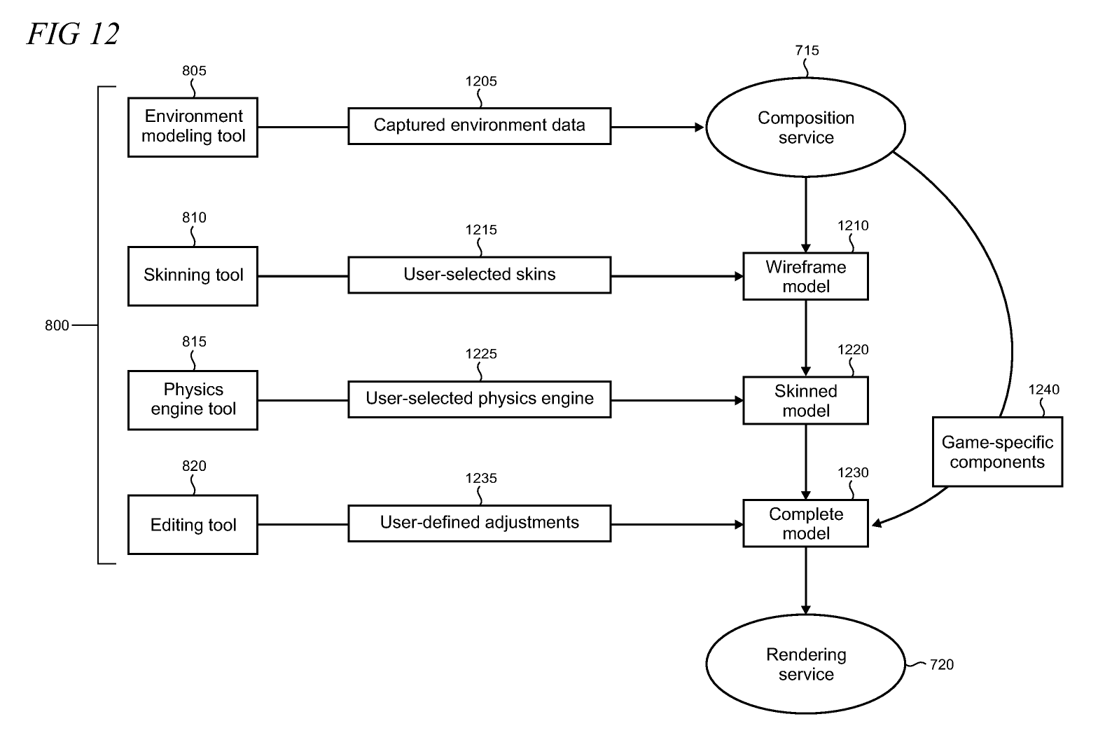

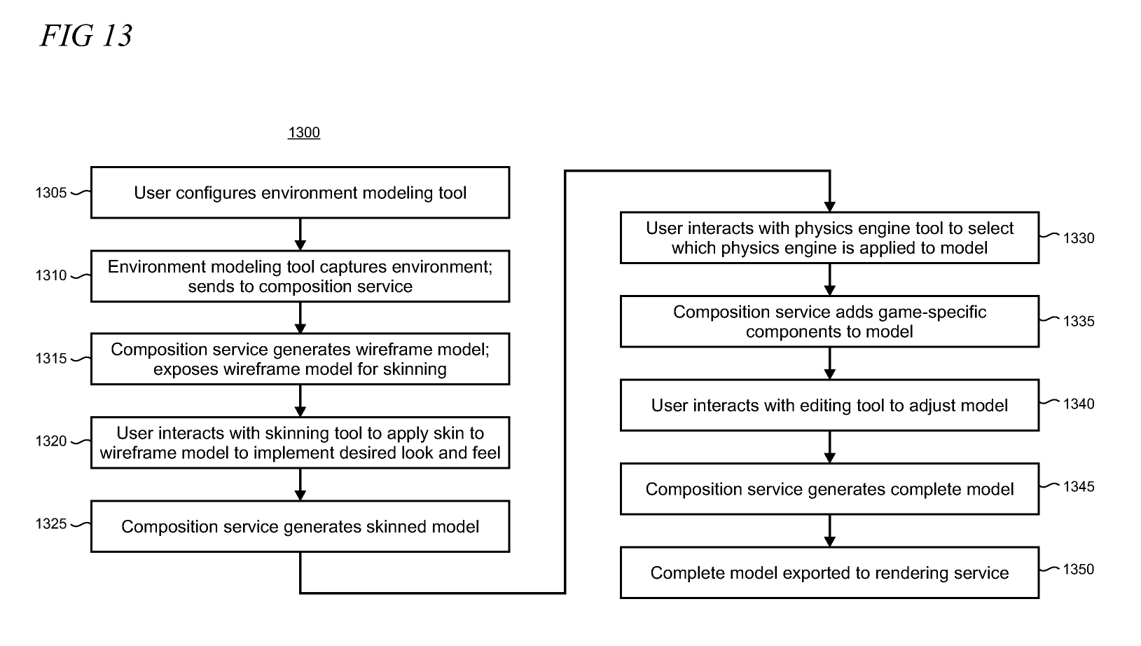

FIG. 12 is a diagram showing illustrative interactions between the tools 800 exposed by the user-generated content application and the composition service and rendering service. FIG. 13 shows a flowchart of an illustrative method 1300 that corresponds to the diagram shown in FIG. 12. Unless specifically stated, the methods or steps shown in the flowcharts in this specification and described in the accompanying text are not constrained to a particular order or sequence. In addition, some of the methods or steps thereof can occur or be performed concurrently and not all the methods or steps have to be performed in a given implementation depending on the requirements of such implementation and some methods or steps may be optionally utilized.

In the step 1305, the user can configure the environment modeling tool 805 to set various data capture parameters. For example, the user may wish to capture just a particular portion of the room to be used in the user's virtual world. Alternatively, the tool can be set to work automatically so that little or no user interaction is typically needed. The environment modeling tool 805 will interoperate with the camera system and multimedia console to capture data 1205 that describes the user's environment, and the application sends the data to the composition service 715, in step 1310.

In step 1315, the composition service 715 takes the data 1205 to generate a wireframe model 1210 of the user's environment and exposes the wireframe model to the skinning tool 810. The user interacts with the skinning tool 810 to apply one or more skins 1215 to the wireframe model to achieve a desired look and feel in step 1320. In typical implementations, as noted above, the user can select from a variety of pre-defined skins or the tool can enable the user to generate a skin and/or upload pictures, video, or other media that may be used in the skinning process.

In step 1325, the composition service 715 generates a skinned model 1220. In step 1330, the user interacts with the physics engine tool to select a desired physics engine 1225 that can be applied to the model when operating in the user-generated dynamic virtual world. The composition service 715 can include game-specific components 1240 to the model in step 1335. For example, such game-specific components 1240 can include particular content, skins, models, characters, or other virtual objects that can be expected to enhance the user-generated dynamic virtual world, enable it be consistent with the game in general (e.g., such as in look and feel, operation, etc.), and/or control behaviors, attributes, and characteristics of objects in the virtual world to improve gameplay and the overall user experience.

In step 1340, the user may interact with the editing tool 820 to implement user-defined adjustments 1235 to the skinned wireframe model. The editing tool 820 can be configured to enable the user to tweak, revise, and/or adjust various aspects of the model. For example, the user may wish to add an object or artifact in the virtual world, reshape it, re-skin it, change its behavior, attributes, or characteristics, and the like. Global characteristics and attributes of the virtual world can also be adjusted by the user through the editing tool in some implementations. Such characteristics and attributes may include, for example, overall lighting, size and shape of environment, and its look/feel.

In step 1345, the composition service 715 generates a complete model 1230 and exports it to the rendering service 720 in step 1350. The compete model 1230 can be stored for future use in some cases, for example using cloud-based storage, or downloaded by the multimedia console 114 and stored locally.

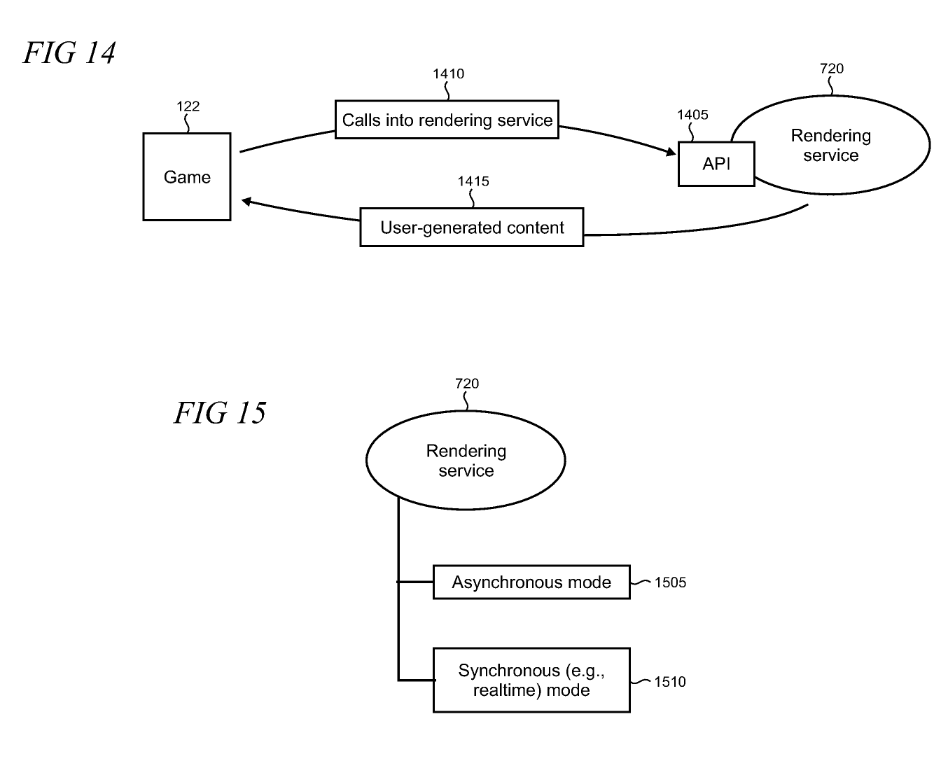

FIG. 14 is a diagram showing illustrative interactions between the game 122 and the rendering service 720. The rendering service 720 can expose an application programming interface (API) 1405 to which the game can place calls 1410 to retrieve user-generated content including, for example, the complete model 1230 for the user's virtual world. In this case, the game 122 can download the model from the rendering service 720, in whole or part, and utilize the model to render scenes for gameplay as if the model was part of the game's native code and/or content. Alternatively, the rendering service 720 can be configured to perform some or all of the computations needed to render a scene using the model 1230 and then deliver the data to the game. That is, in some implementations, the rendering service 720 can perform processing needed to support the gameplay as a remote service. Accordingly, as shown in FIG. 15, the rendering service 720 may perform processing for game support either asynchronously, as indicated by reference numeral 1505, or synchronously as indicated by reference numeral 1510 (i.e., in real time during gameplay).

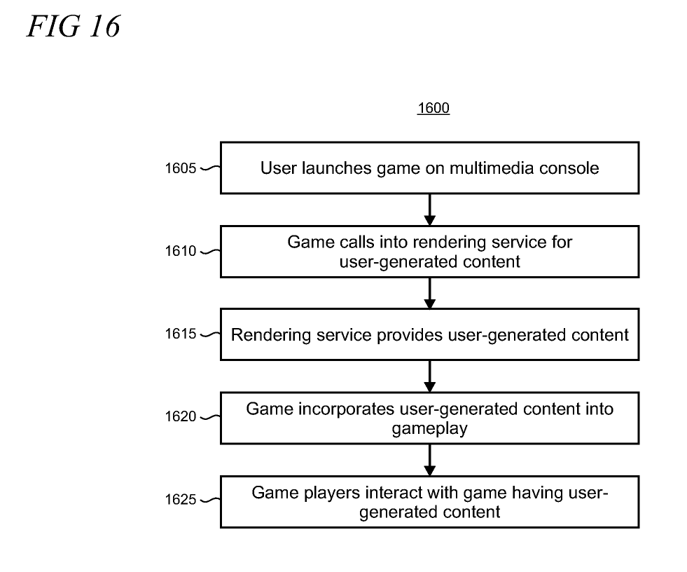

FIG. 16 is a flowchart of an illustrative method 1600 for providing user-generated content to the game 122 from the rendering service 720 that corresponds to the diagram shown in FIG. 14. In step 1605, the user launches the game 122 on the multimedia console 114. In step 1610, the game places one or more calls 1410 into the rendering service 720, for example using the API 1405. In response to the calls 1410 from the game 122, in step 1615, the rendering service 720 provides user-generated content 1415 which can include the complete model, rendered scenes (or portions thereof), and the like using either synchronous or asynchronous delivery.

In step 1620, the game 122 can incorporate the user-generated content 1415 into the gameplay. In step 1625, the user can interact with the game having user-generated content, or in multiplayer games, some or all of the players can interact with the user-generated content.

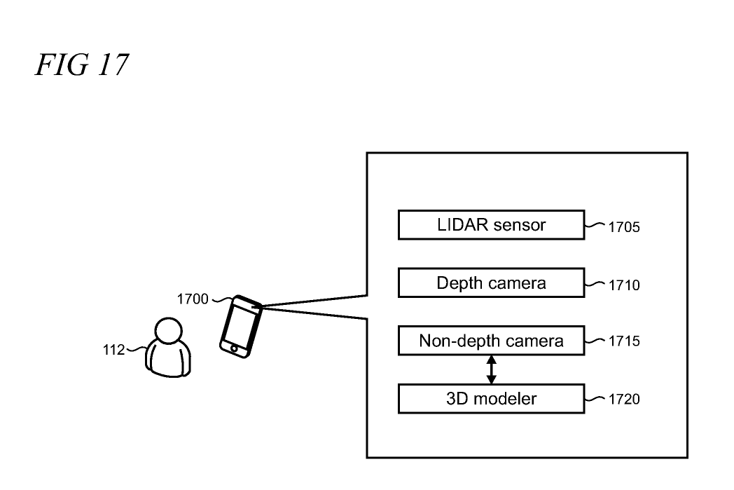

FIG. 17 shows various alternative technologies that may be incorporated into a mobile device 1700 to capture user environments. The mobile device 1700 can include user equipment, mobile phones, cell phones, feature phones, tablet computers, smartphones, handheld computing devices, PDAs (personal digital assistants), portable media players, phablet devices (i.e., combination smartphone/tablet devices), wearable computers, navigation devices such as GPS (Global Positioning System) systems, laptop PCs (personal computers), portable gaming systems, or the like.

The mobile device 1700 may include one or more of the technologies shown including a LIDAR (i.e., light-radar) sensor 1705, depth camera 1710 (e.g., a stereoscopic camera, time-of-flight camera, an infrared camera, etc.), or a non-depth camera 1715 that interoperates with a 3D modeler 1720 that can generate 3D models using multiple 2D pictures taken from different angles). An exemplary 3D modeler includes Photosynth™ by Microsoft Corporation.

In various alternative arrangements, the mobile device 1700 can be utilized to capture user environments other than environments sensed by fixed position sensors such as the camera system 128 shown in FIGS. 1-4. For example, the mobile device 1700 can capture a wide variety of user environments both indoors and outdoors across a range of facilities and locations including parks, cities, shopping malls, points of interest, buildings, ships, automobiles, aircraft, and the like. In some cases, captured environment data can be crowd-sourced from multiple users and multiple mobile devices and be used to generate virtual world models on a large scale basis in some applications. For example, entire neighborhoods or cities can be mapped using the mobile device to generate accurate and comprehensive 3D virtual worlds. Such worlds can be utilized in both gaming and non-gaming applications such as map and search services.

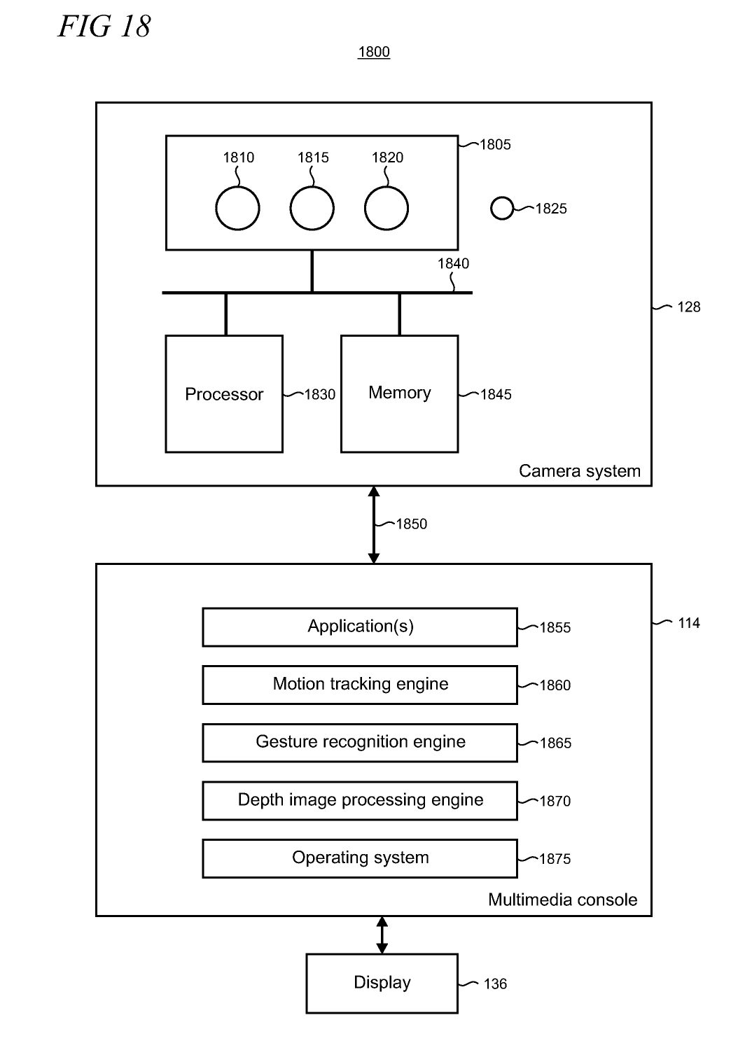

FIG. 18 shows illustrative functional components of the camera system 128 and multimedia console 114 that may be used as part of a target recognition, analysis, and tracking system 1800 to recognize human and non-human targets in a capture area of a physical space monitored by the camera system without the use of special sensing devices attached to the subjects, uniquely identify them, and track them in a three-dimensional space. The camera system 128 may be configured to capture video with depth information including a depth image that may include depth values via any suitable technique including, for example, time-of-flight, structured light, stereo image, or the like. In some implementations, the camera system 128 may organize the calculated depth information into “Z layers,” or layers that may be perpendicular to a Z-axis extending from the depth camera along its line of sight.

As shown in FIG. 18, the camera system 128 includes an image camera component 1805. The image camera component 1805 may be configured to operate as a depth camera that may capture a depth image of a scene. The depth image may include a two-dimensional (“2D”) pixel area of the captured scene where each pixel in the 2D pixel area may represent a depth value such as a distance in, for example, centimeters, millimeters, or the like of an object in the captured scene from the camera. In this example, the image camera component 1805 includes an IR light component 1810, an IR camera 1815, and a visible light RGB camera 1820 that may be configured in an array, as shown, or in an alternative geometry.

Various techniques may be utilized to capture depth video frames. For example, in time-of-flight analysis, the IR light component 1810 of the camera system 128 may emit an infrared light onto the capture area and may then detect the backscattered light from the surface of one or more targets and objects in the capture area using, for example, the IR camera 1815 and/or the RGB camera 1820. In some embodiments, pulsed infrared light may be used such that the time between an outgoing light pulse and a corresponding incoming light pulse may be measured and used to determine a physical distance from the camera system 128 to a particular location on the targets or objects in the capture area. Additionally, the phase of the outgoing light wave may be compared to the phase of the incoming light wave to determine a phase shift. The phase shift may then be used to determine a physical distance from the camera system to a particular location on the targets or objects. Time-of-flight analysis may be used to indirectly determine a physical distance from the camera system 128 to a particular location on the targets or objects by analyzing the intensity of the reflected beam of light over time via various techniques including, for example, shuttered light pulse imaging.

In other implementations, the camera system 128 may use structured light to capture depth information. In such an analysis, patterned light (i.e., light displayed as a known pattern such as a grid pattern or a stripe pattern) may be projected onto the capture area via, for example, the IR light component 1810. Upon striking the surface of one or more targets or objects in the capture area, the pattern may become deformed in response. Such a deformation of the pattern may be captured by, for example, the IR camera 1815 and/or the RGB camera 1820 and may then be analyzed to determine a physical distance from the camera system to a particular location on the targets or objects.

The camera system 128 may utilize two or more physically separated cameras that may view a capture area from different angles, to obtain visual stereo data that may be resolved to generate depth information. Other types of depth image arrangements using single or multiple cameras can also be used to create a depth image. The camera system 128 may further include a microphone 1825. The microphone 1825 may include a transducer or sensor that may receive and convert sound into an electrical signal. The microphone 1825 may be used to reduce feedback between the camera system 128 and the multimedia console 114 in the target recognition, analysis, and tracking system 1800. Additionally, the microphone 1825 may be used to receive audio signals that may also be provided by the user 112 to control applications such as game applications, non-game applications, or the like that may be executed by the multimedia console 114.

The camera system 128 may further include a processor 1830 that may be in operative communication with the image camera component 1805 over a bus 1840. The processor 1830 may include a standardized processor, a specialized processor, a microprocessor, or the like that may execute instructions that may include instructions for storing profiles, receiving the depth image, determining whether a suitable target may be included in the depth image, converting the suitable target into a skeletal representation or model of the target, or any other suitable instruction. The camera system 128 may further include a memory component 1845 that may store the instructions that may be executed by the processor 1830, images or frames of images captured by the cameras, user profiles or any other suitable information, images, or the like. According to one example, the memory component 1845 may include RAM, ROM, cache, Flash memory, a hard disk, or any other suitable storage component. As shown in FIG. 18, the memory component 1845 may be a separate component in communication with the image capture component 1805 and the processor 1830. Alternatively, the memory component 1845 may be integrated into the processor 1830 and/or the image capture component 1805. In one embodiment, some or all of the components 1805, 1810, 1815, 1820, 1825, 1830, 1840, and 1845 of the camera system 128 are located in a single housing.

The camera system 128 operatively communicates with the multimedia console 114 over a communication link 1850. The communication link 1850 may be a wired connection including, for example, a USB (Universal Serial Bus) connection, a Firewire connection, an Ethernet cable connection, or the like and/or a wireless connection such as a wireless IEEE 802.11 connection. The multimedia console 114 can provide a clock to the camera system 128 that may be used to determine when to capture, for example, a scene via the communication link 1845. The camera system 128 may provide the depth information and images captured by, for example, the IR camera 1815 and/or the RGB camera 1820, including a skeletal model and/or facial tracking model that may be generated by the camera system 128, to the multimedia console 114 via the communication link 1850. The multimedia console 114 may then use the skeletal and/or facial tracking models, depth information, and captured images to, for example, create a virtual screen, adapt the user interface, and control apps/games 1855. The apps/games 1855 may include the game 122 (FIG. 1) and user-generated content application 710 (FIG. 7).

A motion tracking engine 1860 uses the skeletal and/or facial tracking models and the depth information to provide a control output to one more apps/games 1855 running on the multimedia console 114 to which the camera system 128 is coupled. The information may also be used by a gesture recognition engine 1865, depth image processing engine 1870, and/or operating system 1875.

The depth image processing engine 1870 uses the depth images to track motion of objects, such as the user and other objects. The depth image processing engine 1870 will typically report to the operating system 1875 an identification of each object detected and the location of the object for each frame. The operating system 1875 can use that information to update the position or movement of an avatar, for example, or other images shown on the display 136, or to perform an action on the user interface.

The gesture recognition engine 1865 may utilize a gestures library (not shown) that can include a collection of gesture filters, each comprising information concerning a gesture that may be performed, for example, by a skeletal model (as the user moves). The gesture recognition engine 1865 may compare the frames captured by the camera system 114 in the form of the skeletal model and movements associated with it to the gesture filters in the gesture library to identify when a user (as represented by the skeletal model) has performed one or more gestures. Those gestures may be associated with various controls of an application and direct the system to open the personalized home screen as described above. Thus, the multimedia console 114 may employ the gestures library to interpret movements of the skeletal model and to control an operating system or an application running on the multimedia console based on the movements.

In some implementations, various aspects of the functionalities provided by the apps/games 1855, motion tracking engine 1860, gesture recognition engine 1865, depth image processing engine 1870, and/or operating system 1875 may be directly implemented on the camera system 128 itself.

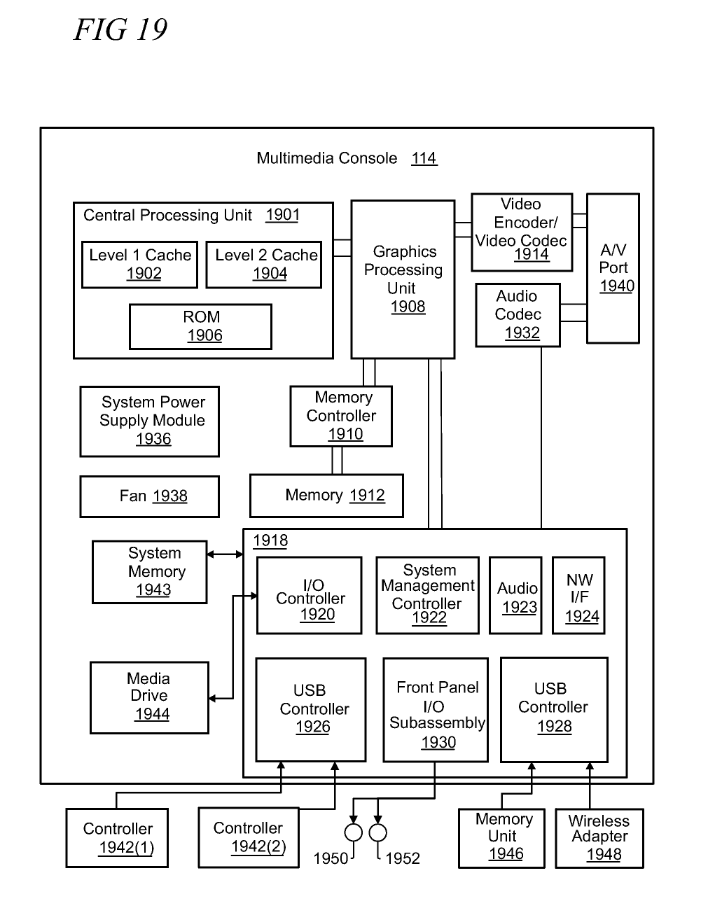

FIG. 19 is an illustrative functional block diagram of the multimedia console 114 shown in FIGS. 1-4. The multimedia console 114 has a central processing unit (CPU) 1901 having a level 1 cache 1902, a level 2 cache 1904, and a Flash ROM (Read Only Memory) 1906. The level 1 cache 1902 and the level 2 cache 1904 temporarily store data and hence reduce the number of memory access cycles, thereby improving processing speed and throughput. The CPU 1901 may be configured with more than one core, and thus, additional level 1 and level 2 caches 1902 and 1904. The Flash ROM 1906 may store executable code that is loaded during an initial phase of a boot process when the multimedia console 114 is powered ON.

A graphics processing unit (GPU) 1908 and a video encoder/video codec (coder/decoder) 1914 form a video processing pipeline for high speed and high resolution graphics processing. Data is carried from the GPU 1908 to the video encoder/video codec 1914 via a bus. The video processing pipeline outputs data to an A/V (audio/video) port 1940 for transmission to a television or other display. A memory controller 1910 is connected to the GPU 1908 to facilitate processor access to various types of memory 1912, such as, but not limited to, a RAM.

The multimedia console 114 includes an I/O controller 1920, a system management controller 1922, an audio processing unit 1923, a network interface controller 1924, a first USB (Universal Serial Bus) host controller 1926, a second USB controller 1928, and a front panel I/O subassembly 1930 that are preferably implemented on a module 1918. The USB controllers 1926 and 1928 serve as hosts for peripheral controllers 1942(1) and 1942(2), a wireless adapter 1948, and an external memory device 1946 (e.g., Flash memory, external CD/DVD ROM drive, removable media, etc.). The network interface controller 1924 and/or wireless adapter 1948 provide access to a network (e.g., the Internet, home network, etc.) and may be any of a wide variety of various wired or wireless adapter components including an Ethernet card, a modem, a Bluetooth module, a cable modem, or the like.

System memory 1943 is provided to store application data that is loaded during the boot process. A media drive 1944 is provided and may comprise a DVD/CD drive, hard drive, or other removable media drive, etc. The media drive 1944 may be internal or external to the multimedia console 114. Application data may be accessed via the media drive 1944 for execution, playback, etc. by the multimedia console 114. The media drive 1944 is connected to the I/O controller 1920 via a bus, such as a Serial ATA bus or other high speed connection (e.g., IEEE 1394).

The system management controller 1922 provides a variety of service functions related to assuring availability of the multimedia console 114. The audio processing unit 1923 and an audio codec 1932 form a corresponding audio processing pipeline with high fidelity and stereo processing. Audio data is carried between the audio processing unit 1923 and the audio codec 1932 via a communication link. The audio processing pipeline outputs data to the A/V port 1940 for reproduction by an external audio player or device having audio capabilities.

The front panel I/O subassembly 1930 supports the functionality of the power button 1950 and the eject button 1952, as well as any LEDs (light emitting diodes) or other indicators exposed on the outer surface of the multimedia console 114. A system power supply module 1936 provides power to the components of the multimedia console 114. A fan 1938 cools the circuitry within the multimedia console 114.

The CPU 1901, GPU 1908, memory controller 1910, and various other components within the multimedia console 114 are interconnected via one or more buses, including serial and parallel buses, a memory bus, a peripheral bus, and a processor or local bus using any of a variety of bus architectures. By way of example, such architectures can include a Peripheral Component Interconnects (PCI) bus, PCI-Express bus, etc.

When the multimedia console 114 is powered ON, application data may be loaded from the system memory 1943 into memory 1912 and/or caches 1902 and 1904 and executed on the CPU 1901. The application may present a graphical user interface that provides a consistent user experience when navigating to different media types available on the multimedia console 114. In operation, applications and/or other media contained within the media drive 1944 may be launched or played from the media drive 1944 to provide additional functionalities to the multimedia console 114.

The multimedia console 114 may be operated as a standalone system by simply connecting the system to a television or other display. In this standalone mode, the multimedia console 114 allows one or more users to interact with the system, watch movies, or listen to music. However, with the integration of broadband connectivity made available through the network interface controller 1924 or the wireless adapter 1948, the multimedia console 114 may further be operated as a participant in a larger network community.

When the multimedia console 114 is powered ON, a set amount of hardware resources are reserved for system use by the multimedia console operating system. These resources may include a reservation of memory (e.g., 16 MB), CPU and GPU cycles (e.g., 5%), networking bandwidth (e.g., 8 kbps), etc. Because these resources are reserved at system boot time, the reserved resources do not exist from the application's view.

In particular, the memory reservation preferably is large enough to contain the launch kernel, concurrent system applications, and drivers. The CPU reservation is preferably constant such that if the reserved CPU usage is not used by the system applications, an idle thread will consume any unused cycles.

With regard to the GPU reservation, lightweight messages generated by the system applications (e.g., pop-ups) are displayed by using a GPU interrupt to schedule code to render pop-ups into an overlay. The amount of memory needed for an overlay depends on the overlay area size and the overlay preferably scales with screen resolution. Where a full user interface is used by the concurrent system application, it is preferable to use a resolution independent of application resolution. A scaler may be used to set this resolution such that the need to change frequency and cause a TV re-sync is eliminated.

After the multimedia console 114 boots and system resources are reserved, concurrent system applications execute to provide system functionalities. The system functionalities are encapsulated in a set of system applications that execute within the reserved system resources described above. The operating system kernel identifies threads that are system application threads versus gaming application threads. The system applications are preferably scheduled to run on the CPU 1901 at predetermined times and intervals in order to provide a consistent system resource view to the application. The scheduling is to minimize cache disruption for the gaming application running on the console.

When a concurrent system application requires audio, audio processing is scheduled asynchronously to the gaming application due to time sensitivity. A multimedia console application manager (described below) controls the gaming application audio level (e.g., mute, attenuate) when system applications are active.

Input devices (e.g., controllers 1942(1) and 1942(2)) are shared by gaming applications and system applications. The input devices are not reserved resources, but are to be switched between system applications and the gaming application such that each will have a focus of the device. The application manager preferably controls the switching of input stream, without knowledge of the gaming application's knowledge and a driver maintains state information regarding focus switches.

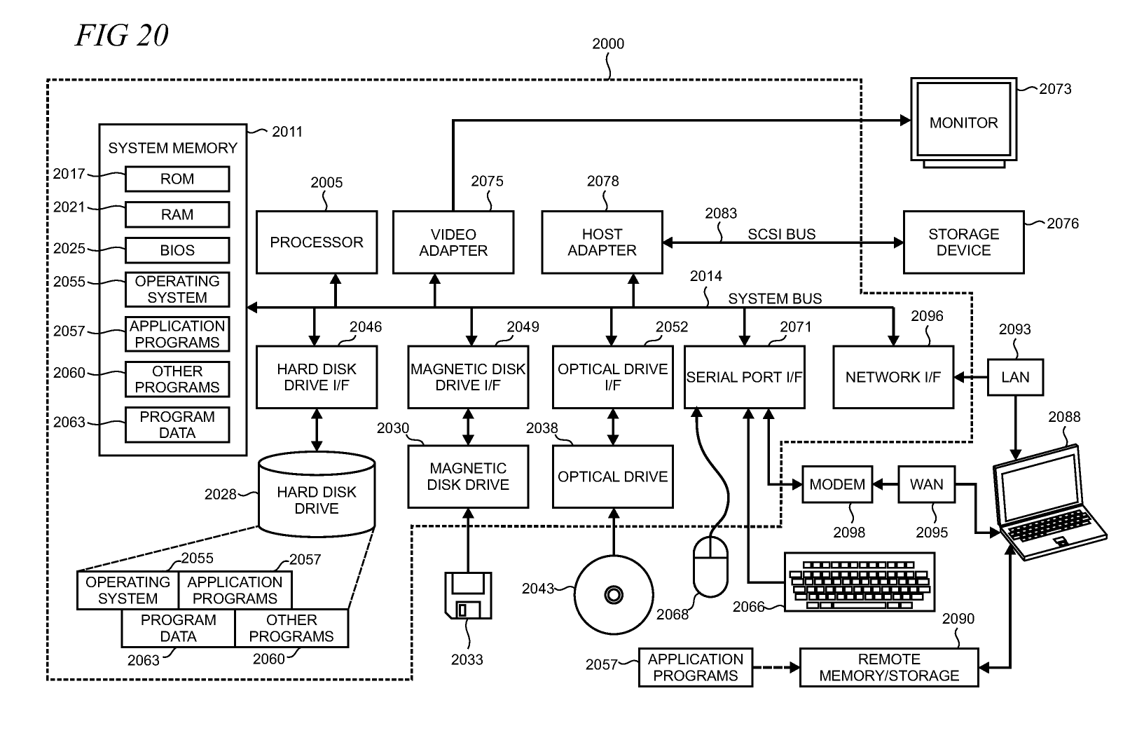

FIG. 20 is a simplified block diagram of an illustrative computer system 2000 such as a PC, client device, or server with which the present user-generated dynamic virtual worlds may be implemented. Computer system 2000 includes a processing unit 2005, a system memory 2011, and a system bus 2014 that couples various system components including the system memory 2011 to the processing unit 2005. The system bus 2014 may be any of several types of bus structures including a memory bus or memory controller, a peripheral bus, and a local bus using any of a variety of bus architectures. The system memory 2011 includes read only memory (“ROM”) 2017 and random access memory (“RAM”) 2021. A basic input/output system (“BIOS”) 2025, containing the basic routines that help to transfer information between elements within the computer system 2000, such as during startup, is stored in ROM 2017. The computer system 2000 may further include a hard disk drive 2028 for reading from and writing to an internally disposed hard disk (not shown), a magnetic disk drive 2030 for reading from or writing to a removable magnetic disk 2033 (e.g., a floppy disk), and an optical disk drive 2038 for reading from or writing to a removable optical disk 2043 such as a CD (compact disc), DVD (digital versatile disc), or other optical media. The hard disk drive 2028, magnetic disk drive 2030, and optical disk drive 2038 are connected to the system bus 2014 by a hard disk drive interface 2046, a magnetic disk drive interface 2049, and an optical drive interface 2052, respectively. The drives and their associated computer readable storage media provide non-volatile storage of computer readable instructions, data structures, program modules, and other data for the computer system 2000. Although this illustrative example shows a hard disk, a removable magnetic disk 2033, and a removable optical disk 2043, other types of computer readable storage media which can store data that is accessible by a computer such as magnetic cassettes, flash memory cards, digital video disks, data cartridges, random access memories (“RAMs”), read only memories (“ROMs”), and the like may also be used in some applications of the present user-generated dynamic virtual worlds. In addition, as used herein, the term computer readable storage medium includes one or more instances of a media type (e.g., one or more magnetic disks, one or more CDs, etc.). For purposes of this specification and the claims, the phrase “computer-readable storage media” and variations thereof, does not include waves, signals, and/or other transitory and/or intangible communication media.

A number of program modules may be stored on the hard disk, magnetic disk 2033, optical disk 2043, ROM 2017, or RAM 2021, including an operating system 2055, one or more application programs 2057, other program modules 2060, and program data 2063. A user may enter commands and information into the computer system 2000 through input devices such as a keyboard 2066 and pointing device 2068 such as a mouse. Other input devices (not shown) may include a microphone, joystick, game pad, satellite dish, scanner, trackball, touchpad, touch screen, touch-sensitive module or device, gesture-recognition module or device, voice recognition module or device, voice command module or device, or the like. These and other input devices are often connected to the processing unit 2005 through a serial port interface 2071 that is coupled to the system bus 2014, but may be connected by other interfaces, such as a parallel port, game port, or USB. A monitor 2073 or other type of display device is also connected to the system bus 2014 via an interface, such as a video adapter 2075. In addition to the monitor 2073, personal computers typically include other peripheral output devices (not shown), such as speakers and printers. The illustrative example shown in FIG. 20 also includes a host adapter 2078, a Small Computer System Interface (“SCSI”) bus 2083, and an external storage device 2076 connected to the SCSI bus 2083.

The computer system 2000 is operable in a networked environment using logical connections to one or more remote computers, such as a remote computer 2088. The remote computer 2088 may be selected as another personal computer, a server, a router, a network PC, a peer device, or other common network node, and typically includes many or all of the elements described above relative to the computer system 2000, although only a single representative remote memory/storage device 2090 is shown in FIG. 20. The logical connections depicted in FIG. 20 include a local area network (“LAN”) 2093 and a wide area network (“WAN”) 2095. Such networking environments are often deployed, for example, in offices, enterprise-wide computer networks, intranets, and the Internet.

When used in a LAN networking environment, the computer system 2000 is connected to the local area network 2093 through a network interface or adapter 2096. When used in a WAN networking environment, the computer system 2000 typically includes a broadband modem 2098, network gateway, or other means for establishing communications over the wide area network 2095, such as the Internet. The broadband modem 2098, which may be internal or external, is connected to the system bus 2014 via a serial port interface 2071. In a networked environment, program modules related to the computer system 2000, or portions thereof, may be stored in the remote memory storage device 2090. It is noted that the network connections shown in FIG. 20 are illustrative and other means of establishing a communications link between the computers may be used depending on the specific requirements of an application of the present user-generated dynamic virtual worlds. It may be desirable and/or advantageous to enable other types of computing platforms other than the multimedia console 114 to implement the present user-generated dynamic virtual worlds in some applications.

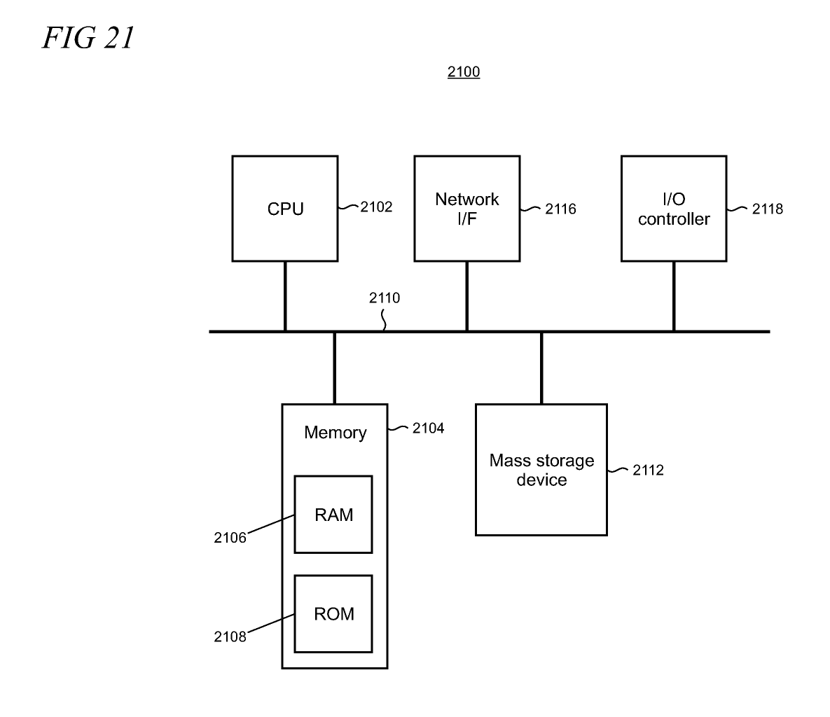

FIG. 21 shows an illustrative architecture 2100 for a computing platform or device capable of executing the various components described herein for the user-generated dynamic virtual worlds. Thus, the architecture 2100 illustrated in FIG. 21 shows an architecture that may be adapted for a server computer, mobile phone, a PDA (personal digital assistant), a smartphone, a desktop computer, a netbook computer, a tablet computer, GPS (Global Positioning System) device, gaming console, and/or a laptop computer. The architecture 2100 may be utilized to execute any aspect of the components presented herein.

The architecture 2100 illustrated in FIG. 21 includes a CPU 2102, a system memory 2104, including a RAM 2106 and a ROM 2108, and a system bus 2110 that couples the memory 2104 to the CPU 2102. A basic input/output system containing the basic routines that help to transfer information between elements within the architecture 2100, such as during startup, is stored in the ROM 2108. The architecture 2100 further includes a mass storage device 2112 for storing software code or other computer-executed code that is utilized to implement applications, the file system, and the operating system.

The mass storage device 2112 is connected to the CPU 2102 through a mass storage controller (not shown) connected to the bus 2110. The mass storage device 2112 and its associated computer-readable storage media provide non-volatile storage for the architecture 2100. Although the description of computer-readable storage media contained herein refers to a mass storage device, such as a hard disk or CD-ROM drive, it should be appreciated by those skilled in the art that computer-readable media can be any available computer storage media that can be accessed by the architecture 2100.

By way of example, and not limitation, computer-readable storage media may include volatile and non-volatile, removable and non-removable media implemented in any method or technology for storage of information such as computer-readable instructions, data structures, program modules or other data. For example, computer-readable media includes, but is not limited to, RAM, ROM, EPROM (erasable programmable read only memory), EEPROM (electrically erasable programmable read only memory), Flash memory or other solid state memory technology, CD-ROM, DVDs, HD-DVD (High Definition DVD), BLU-RAY, or other optical storage, magnetic cassettes, magnetic tape, magnetic disk storage or other magnetic storage devices, or any other medium which can be used to store the desired information and which can be accessed by the architecture 2100.

According to various embodiments, the architecture 2100 may operate in a networked environment using logical connections to remote computers through a network. The architecture 2100 may connect to the network through a network interface unit 2116 connected to the bus 2110. It should be appreciated that the network interface unit 2116 also may be utilized to connect to other types of networks and remote computer systems. The architecture 2100 also may include an input/output controller 2118 for receiving and processing input from a number of other devices, including a keyboard, mouse, or electronic stylus (not shown in FIG. 21). Similarly, the input/output controller 2118 may provide output to a display screen, a printer, or other type of output device (also not shown in FIG. 21).

It should be appreciated that the software components described herein may, when loaded into the CPU 2102 and executed, transform the CPU 2102 and the overall architecture 2100 from a general-purpose computing system into a special-purpose computing system customized to facilitate the functionality presented herein. The CPU 2102 may be constructed from any number of transistors or other discrete circuit elements, which may individually or collectively assume any number of states. More specifically, the CPU 2102 may operate as a finite-state machine, in response to executable instructions contained within the software modules disclosed herein. These computer-executable instructions may transform the CPU 2102 by specifying how the CPU 2102 transitions between states, thereby transforming the transistors or other discrete hardware elements constituting the CPU 2102.

Encoding the software modules presented herein also may transform the physical structure of the computer-readable storage media presented herein. The specific transformation of physical structure may depend on various factors, in different implementations of this description. Examples of such factors may include, but are not limited to, the technology used to implement the computer-readable storage media, whether the computer-readable storage media is characterized as primary or secondary storage, and the like. For example, if the computer-readable storage media is implemented as semiconductor-based memory, the software disclosed herein may be encoded on the computer-readable storage media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable storage media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the architecture 2100 in order to store and execute the software components presented herein. It also should be appreciated that the architecture 2100 may include other types of computing devices, including hand-held computers, embedded computer systems, smartphones, PDAs, and other types of computing devices known to those skilled in the art. It is also contemplated that the architecture 2100 may not include all of the components shown in FIG. 21, may include other components that are not explicitly shown in FIG. 21, or may utilize an architecture completely different from that shown in FIG. 21.

Based on the foregoing, it should be appreciated that technologies for a user-generated dynamic virtual worlds have been disclosed herein. Although the subject matter presented herein has been described in language specific to computer structural features, methodological and transformative acts, specific computing machinery, and computer-readable storage media, it is to be understood that the invention defined in the appended claims is not necessarily limited to the specific features, acts, or media described herein. Rather, the specific features, acts, and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed:

1. A method for enabling creation of a virtual world for use in a user experience, comprising:
providing an environment modeling tool that employs an image capture device with depth sensing capabilities for capturing data that is descriptive of a user environment;
providing a skinning tool for applying a surface texture to a model generated using the captured data;
providing a physics engine tool for applying a physics engine to the model, the physics engine controlling behavior of the model when utilized in the user experience; and
providing an editing tool for adjusting attributes of the model when utilized in the user experience.

2. The method of claim 1 further including configuring the skinning tool to enable selection among one or more pre-defined skins.

3. The method of claim 1 further including configuring the skinning tool to enable one of user-selected pictures, video, or media to be utilized as a skin on the model.

4. The method of claim 1 further including configuring the editing tool to enable control of lighting in the virtual world.

5. The method of claim 1 further including configuring the editing tool to enable new objects to be added to the model, or enable characteristics of existing objects in the model to be changed, the characteristics including shape, size, or behaviors.

6. The method of claim 1 in which the user experience is supported by a video game.

7. One or more computer-readable memories containing instructions which, when executed by one or more processors disposed in an electronic device, perform a method for providing a virtual world generation platform, the method comprising:
exposing a composition service for receiving descriptive data of a user environment, the data being captured by a device having depth sensing capabilities;
generating a wireframe model of the user environment;
applying one or more user-selected skins to the wireframe model;
applying one or more user-selected physics engines to the wireframe model to create a user-generated virtual world that exhibits behavior that is controlled by the physics engine during a game; and
exposing the user-generated virtual world to the game to incorporate the user-generated virtual world into gameplay supported by the game.

8. The one or more computer-readable memories of claim 7 in which the device having depth sensing capabilities includes one of LIDAR device or camera system, the camera system being one of 3D (three dimensional) depth camera, or 2D (two dimensional) non-depth camera that is operated in conjunction with a 3D modeler that creates 3D models from a plurality of 2D images.

9. The one or more computer-readable memories of claim 7 further including configuring the physics engine to utilize physics that are applicable to different environments, the environments including one of real-world, underwater, outer space, or cartoon.

10. The one or more computer-readable memories of claim 7 further including providing an application programming interface (API) that supports calls from the game and provides a service or data in response to the API calls.

11. The one or more computer-readable memories of claim 7 further including adjusting attributes of the user-generated virtual world in response to user input.

12. The one or more computer-readable memories of claim 11 in which the attributes include one or more of lighting, look and feel, object behavior, object appearance, object size, or object shape.

13. The one or more computer-readable memories of claim 7 further including adding new objects to the user-generated virtual world in response to user input.

14. The one or more computer-readable memories of claim 7 further including exposing the user-generated virtual world through a rendering service, the rendering service providing a complete model of the user-generated virtual world to the game, or performing remote code execution in support of user experiences that employ the user-generated virtual world in the game.

15. The one or more computer-readable memories of claim 7 further including facilitating the user-generated virtual world to be shared with players of the game.

16. A system, comprising:
one or more processors;
a camera system having depth sensing capabilities; and
one or more computer-readable memories storing instructions which, when executed by the one or more processors, implement a set of tools for creating a user-generated virtual world that is part of a user experience supported by an application, the toolset implementing a method comprising
capturing a user environment using the camera system,
generating data that describes the user environment in three dimensions, the user environment including objects,
receiving a model of the user environment including the objects, and
controlling the appearance and behavior of the modeled user environment when utilized during runtime of the application,

17. The system of claim 16 further comprising sending the data to a remote service which uses the data to generate the model and receiving the model from the remote service.

18. The system of claim 16 in which the camera system uses one of infrared scattering, structured light, or time-of-flight to implement the depth sensing capabilities.

19. The system of claim 16 in which the camera system incorporates LIDAR.

20. The system of claim 16 in which the camera system is utilized in combination with a multimedia console.
